(19) United States
(12) Patent Application Publication
(10) Pub. No.: US 2007/0094369 A1
(43) Pub. Date: Apr. 26, 2007

(54) Methods and devices for disconnecting external storage devices from a network-attached storage device

(76) Inventor: David H. Hanes, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/259,582

(22) Filed: Oct. 26, 2005

(51) Int. Cl. G06F 15/173

(52) U.S. Cl. 709/223

(57) ABSTRACT

Various embodiments of the present invention are directed to devices and methods for disconnecting storage devices from a network-attached storage device. In one embodiment of the present invention, a network-attached storage device includes a bus that interconnects a central-processing unit, internal storage, and a port. The port is capable of interconnecting to an external storage device. The network-attached storage device also includes a control program stored in the internal storage and executed by the central-processing unit that responds to an indication that the external storage device is to be disconnected. The network-attached storage device may also include a disconnection indicator that indicates that the external storage device is ready to be disconnected from the network-attached storage device.

### TECHNICAL FIELD

The present invention relates to network-attached storage devices, and, in particular, to methods and devices for managing the disconnection of an external storage device that is connected to a network-attached storage device.

### BACKGROUND OF THE INVENTION

As computer systems have become faster, and more reliable, there has been a corresponding demand for larger capacity, faster, and more reliable external storage devices. Data is typically stored in one or more mass external storage devices, such as magnetic disc drives, attached to a single computer system. However, with the advent of computer area networks, such as local-area networks (“LANs”) and wide-area networks (“WANs”), host computer systems may be alternatively connected to remote shared external storage devices, such as magnetic hard disc drives, optical disc drives, tape drives, and other storage devices via computer networks. The shared external storage devices may be connected to a network-attached storage device (“NAS”) that is connected to the local area network. The NAS manages the transfer of data between the host computer systems in the computer area network and the external storage devices. A NAS typically employs a standard protocol, such as Transmission Control Protocol/Internet Protocol, Internet Package Exchange, Server Message Block, Common File System, or Network Control Protocol, to allow for exchange of data between the NAS and remote host computers via the network.

FIG. 1 illustrates an example of a LAN that includes a NAS. In FIG. 1, LAN 100 includes Ethernets 101 and 102, three hosts 103-105, a bridge 106, and a NAS 107. The Ethernets 101 and 102 can be a wireless infrastructure, coaxial cables, unshielded twisted pair wires, or optical fibers. The hosts 103-105 can be computers that provide end users with services, such as computation and database access, perform network control functions, and provide platforms for developing software. Each host can also be connected to a local storage device, such as local storage device 108 connected to the host 104. The bridge 106 provides a link for routing signals between the two Ethernets 101 and 102, allowing devices directly connected to one of the two Ethernets to communicate with devices attached to the other of the two Ethernets. The NAS 107 is interconnected to the Ethernet 101 and is located between remote hosts 103-105 and a number of external storage devices, such as external storage device 109. The NAS 107 controls the transfer of data between the hosts 103-105 and the external storage devices.

The external storage devices are typically connected to a NAS via an external bus, such as a universal serial bus (“USB”), a high performance serial bus, such as an IEEE 1394 serial bus, serial ATA, and other external buses. However, the external buses connecting an external storage device to a NAS can be disconnected from a NAS at any time, even during a data stream transmission between the NAS and an external storage device. As a result, any data being transmitted between the NAS and the external storage devices may be corrupted or lost. For example, an external storage device can be disconnected during transfer of received data to the external storage device, resulting in data loss or storage of only a portion of the received data. A NAS may include a memory resident data cache in which received data is temporarily stored before being written to an external storage device. Disconnection of an external-storage-device target for the received data may result in data loss due to the cached data eventually being discarded or overwritten. In either case, it is difficult for a remote computer user or network administrator to know whether or not all of the data sent from remote computers to a NAS has been successfully transferred to an external storage device prior to disconnection of the external storage device. Therefore, network designers, network users, and systems administrators have recognized a need for addressing data loss due to storage device disconnections from a NAS.

### SUMMARY OF THE INVENTION

Various embodiments of the present invention are directed to devices and methods for disconnecting storage devices from a network-attached storage device. In one embodiment of the present invention, a network-attached storage device includes a bus that interconnects a central-processing unit, internal storage, and a port. The port is capable of interconnecting to an external storage device. The network-attached storage device also includes a control program stored in the internal storage and executed by the central-processing unit that responds to an indication that the external storage device is to be disconnected. The network-attached storage device may also include a disconnection indicator that indicates that the external storage device is ready to be disconnected from the network-attached storage device.

### BRIEF DESCRIPTION OF THE DRAWINGS

FIG. 1 illustrates an example of a local-area network that includes a network-attached storage device.

FIG. 2 illustrates an exemplary network-attached storage device architecture that includes four externally connected storage devices that represents one of many embodiments of the present invention.

FIG. 3 illustrates a first console that includes a user interface for disconnecting external storage devices from the network-attached storage device shown in FIG. 2 that represents one of many embodiments of the present invention.

FIGS. 4A-4B illustrate an exemplary operation of the console shown in FIG. 3 that represents one of many embodiments of the present invention.

FIG. 5 illustrates a second console that includes a user interface for disconnecting an external storage device from the network-attached storage device shown in FIG. 2 that represents one of many embodiments of the present invention.

FIGS. 6A-6B illustrate an exemplary operation of the console shown in FIG. 5 that represents one of many embodiments of the present invention.

FIG. 7A illustrates a console having buttons and indicator lights located next to ports that represents one of many embodiments of the present invention.

FIG. 7B illustrates a console having buttons and indicator lights located next to slots that each supports an external storage device and that represents an embodiment of the present invention.

FIG. 8 illustrates a control-flow diagram that describes one of many embodiments for disconnecting an external storage device from a network-attached storage device.

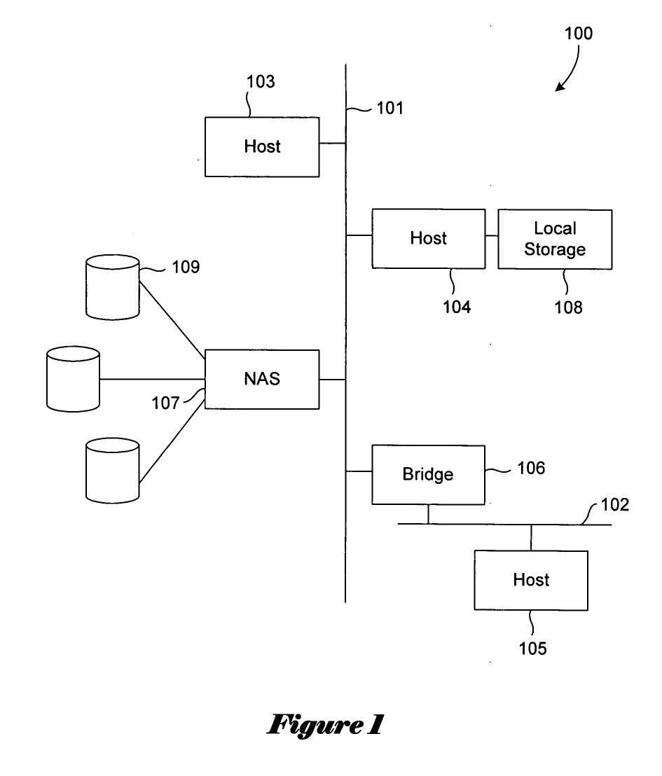

### DETAILED DESCRIPTION OF THE INVENTION

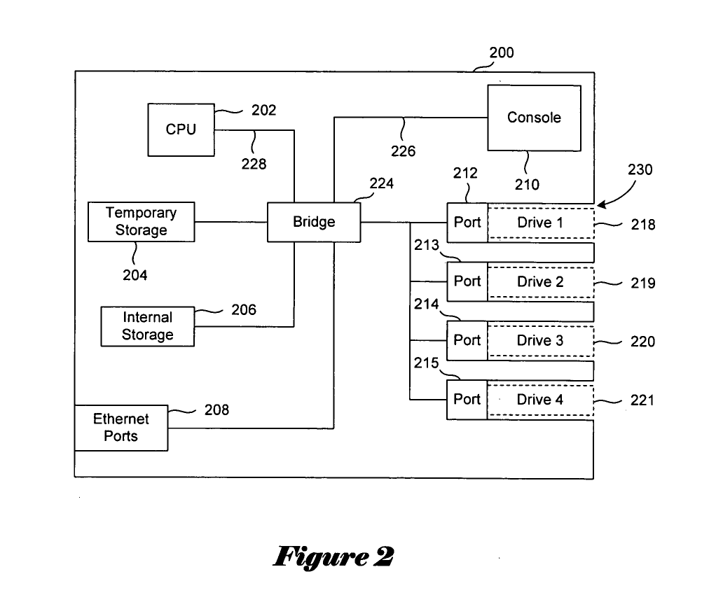

Various embodiments of the present invention are directed to methods and devices for disconnecting externally connected storage devices from a NAS in order to reduce the possibility of corrupting or losing data that is being transmitted between the externally connected storage devices and the NAS. FIG. 2 illustrates an exemplary NAS architecture connected to four external storage devices that represents one of many embodiments of the present invention. In FIG. 2, a NAS 200 comprises a central processing unit (“CPU”) 202, temporary storage 204, internal storage 206, Ethernet ports 208, a console 210, and ports 212-215 that interconnect internal buses with external communications media and, through external communications media, to external storage devices 218-221, respectively. The ports 212-215 generally include hardware interfaces, such as USB ports, IEEE 1394 serial ports, serial ATA ports, or other ports, that interconnect the external storage devices 218-221 with one or more internal busses. One or more bridges 224 route signals from one internal bus to another. For example, bridge 224 routes signals transmitted from the console 210 to the CPU 202 via buses 226 and 228. The external storage devices can either be located outside the NAS housing or inserted into slots located within the NAS housing, such as a slot 230 that houses the external storage device 218, as shown in FIG. 2.

The CPU 202 executes an operating system or control program that directs the storage operations, such as transmitting data between the temporary storage 204, Ethernet ports 208, and the ports 212-215. The temporary storage 204 can be any of various types of random access memories that temporarily stores data sent to the NAS 200 prior to writing the data to the external storage devices 218-221. The Ethernet ports 208 interconnect the NAS 200 to a LAN, or other kind of computer network, so that data can be transmitted between the network and the NAS 200.

The internal storage 206 stores the operating system or control program that directs operation of the NAS 200. Internal storage 206 can be read only memory (“ROM”), programmable ROM, erasable programmable ROM, electronically erasable programmable ROM, flash memory, a hard disc drive, or any other suitable form of internal storage. Programmable ROM can be implemented using one or more chips that can be written to only one time, and erasable programmable ROM can be implemented using one or more chips that can be erased and reprogrammed with different routines or control programs. The operating system or control program includes instructions for deactivating an external storage device to be disconnected from the NAS so that the external storage device can be disconnected from the NAS. The deactivation instructions may include instructions that terminate the transmission of data between the external storage device and host computer systems connected to the area network, instructions that direct the transmission of data stored in the temporary storage 204 that is directed to the external storage device to be disconnected, and instructions that terminate any further electrical transmissions to the external storage device to be disconnected.

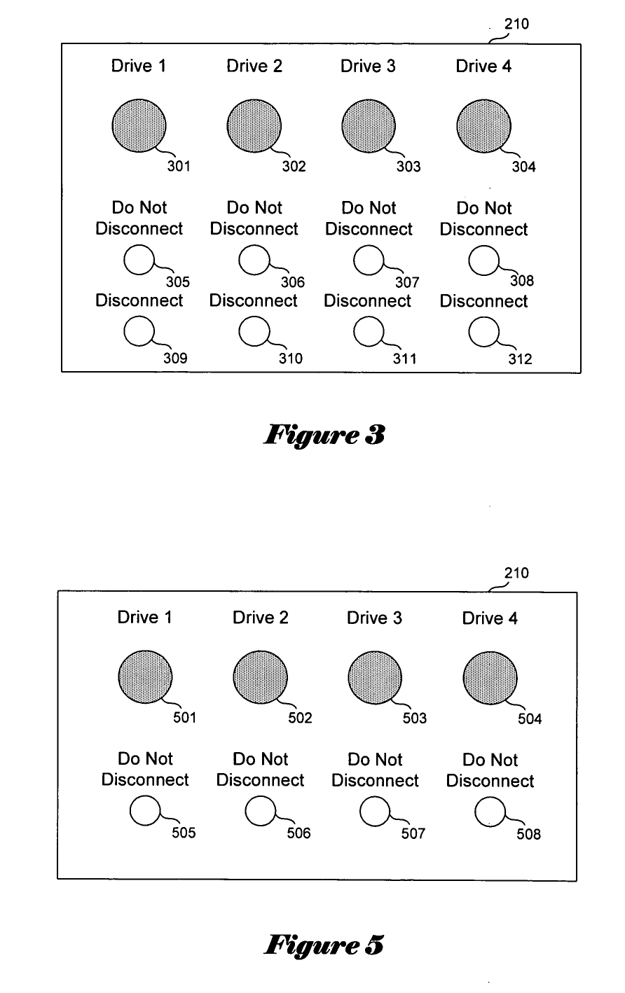

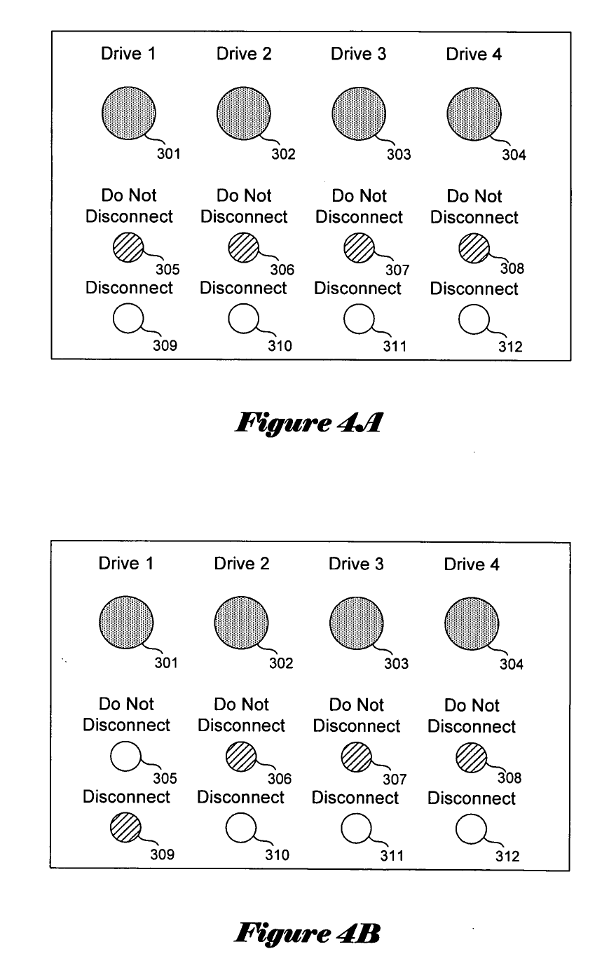

The console 210 may include a combination of readouts, indicator lights, or displays and an input device, such as a keyboard, buttons, or switches, that allows an operator, such as a system administrator, to control, monitor, and interact with the NAS 200. The console 210 can be located anywhere on the NAS 200, such as the top, front, back, or sides. FIGS. 3-7B illustrate four of many different kinds of consoles that can be employed in accordance with the present invention, each representing an embodiment of the present invention. FIG. 3 illustrates a first console that includes a user interface for disconnecting the external storage devices 218-221 from the NAS 200 that represents one of many embodiments of the present invention. In FIG. 3, as well as FIGS. 4-7B, buttons are represented by stippled circles, such as stippled circles 301-304, and disconnection indicators are lights that are represented by open circles, such as open circles 305-312. The buttons, when depressed, launch a routine or control program that disconnects a corresponding external storage device from the NAS 200, such as one of the external storage devices 218-221. Each button is provided with a label that identifies the corresponding storage device. For example, the button 301 is labeled “Drive 1,” and corresponds to an external storage device 218 shown in FIG. 2, that is attached to a first disk-drive port. The indicator lights 305-312 can be light bulbs, such as light emitting diodes (“LED”), and are used to indicate whether or not an external storage device is ready to be disconnected. In FIG. 3, indicator lights 305-308 are each labeled “Do Not Disconnect,” so that when an indicator light is lighted, or “ON,” a NAS operator is aware that the corresponding storage device is not ready to be disconnected from the NAS 200. Indicator lights 309-312 are each labeled “Disconnect,” so that when a second row light is lighted, or “ON,” a NAS operator is aware that the corresponding storage device is ready to be disconnected from the NAS 200.

FIGS. 4A-4B illustrates an exemplary operation of the console shown in FIG. 3 that represents one of many embodiments of the present invention. In FIGS. 4A-6B, hash-marked circles 305-308 represent lighted indicator lights. In FIG. 4A, indicator lights 305-308 are lighted and indicate that the external storage devices 218-221 are not ready to be disconnected from the NAS 200, because the external storage devices 218-221 may be in use and/or the temporary storage 204 may contain data that is to be stored on the external storage devices 218-221. Depressing button 301 launches execution of the routines or control programs stored in internal storage 206 that deactivates the external storage device 218. In FIG. 4B, after storage device 218 has been deactivated, indicator light 305 is “OFF,” and lighted indicator light 309 is “ON” indicating that external storage device 218 can be disconnected from the NAS 200.

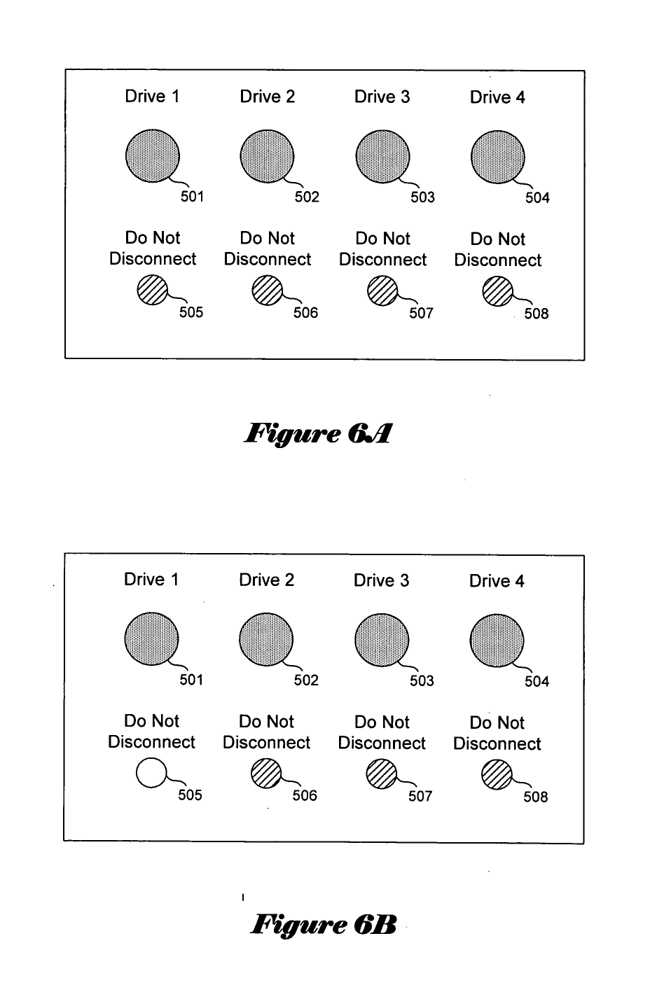

In an alternate embodiment of the present invention, a single row of indicator lights located below each button on the console can be used to indicate whether or not an external storage device is ready to be disconnected from a NAS. FIG. 5 illustrates a second console that includes a user interface for disconnecting an external storage device from the NAS 200 shown in FIG. 2 that represents one of many embodiments of the present invention. In FIG. 5, depressing one of the buttons 501-504 launches the routine or control program stored in the internal storage 206 that disconnects a corresponding external storage device. Indicator lights 505-508 are each labeled “Do Not Disconnect” so that when an indicator light is lighted, or “ON,” a NAS operator is aware that the corresponding storage device is not ready to be disconnected.

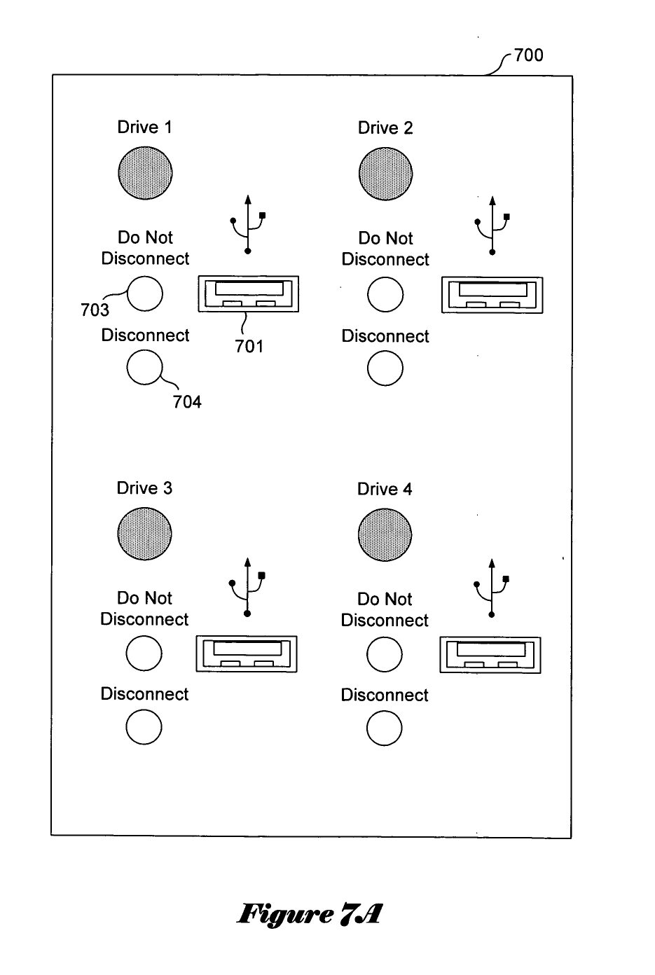

FIGS. 6A-6B illustrate an exemplary operation of the console shown in FIG. 5 that represents one of many embodiments of the present invention. In FIG. 6A, lighted indicators lights 505-508 indicate that the corresponding storage devices are not ready to be disconnected from the NAS 200. In FIG. 6B, after depressing the button 501, the external storage device 218 is deactivated, the indicator light 505 is “OFF,” and the external storage device 218 can be disconnected from the NAS 200. In an alternate embodiment of the present invention, the single row of indicator lights 501-504 can be labeled “Disconnect” so that after a button has been depressed and a corresponding storage device is ready to be disconnected, the indicator light located below the button is lighted, or “ON,” and a NAS operator is aware that the corresponding storage device is ready to be disconnected.

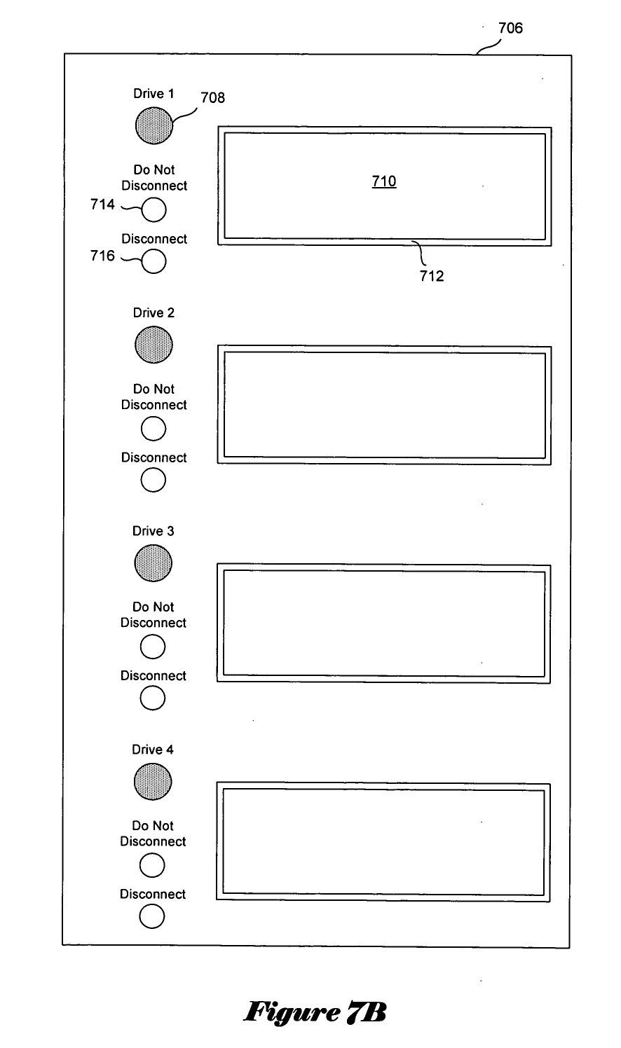

In alternate embodiments of the present invention, the console may comprise buttons and indicator lights located in close proximity to a port or to an external storage device located within a slot of the network-attached storage device. FIG. 7A illustrates a console 700 having buttons and indicator lights located next to ports that represents one of many embodiments of the present invention. The console 700 includes four ports, such as port 701. Depressing a button launches a routine or control program that deactivates the storage devices connected to the adjacent ports, as described above with respect to FIGS. 3-4B. For example, depressing button 702 launches routines or a control program that deactivates an external storage device connected to port 701, and indicator lights 703 and 704 indicate whether or not the external storage device is ready to be disconnected. FIG. 7B illustrates a console 706 having buttons and indicator lights located next to each slot that each supports an external storage device and that represents an embodiment of the present invention. Depressing button 708 launches routines or a control program that deactivates an external storage device 710 located in slot 712, and indicator lights 714 and 716 indicate whether or not the external storage device 710 can be removed from the slot 712. The console 706 may also include locks that fasten each external storage device inserted into a slot until the corresponding storage device is ready to be disconnected.

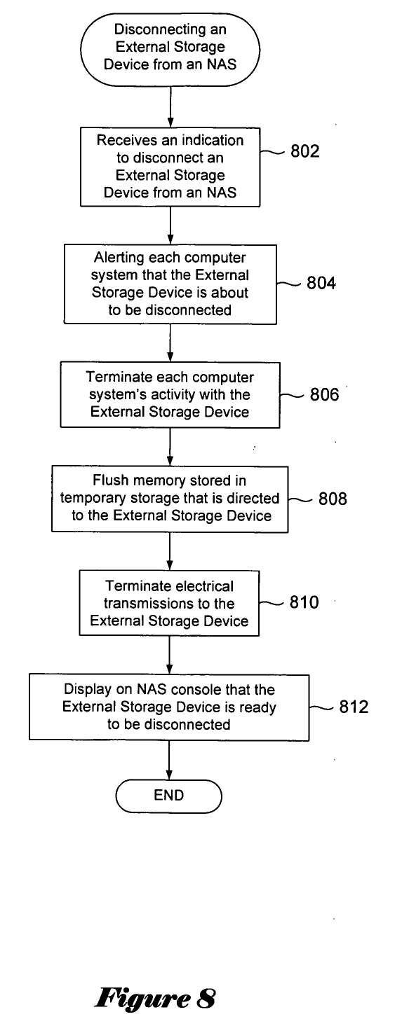

FIG. 8 illustrates a control-flow diagram that describes one of many embodiments for disconnecting an external storage device from a NAS. In step 802, a NAS receives an indication for disconnecting a particular storage device from the NAS. A NAS can receive an indication by depressing a button located on a console that launches routines or control program to deactivate the external storage device, such as deactivating an external storage device using the console 210 described above with reference to FIGS. 4A-4B and FIGS. 6A-6B or the console 700 described above with reference to FIG. 7A. In step 804, each computing device connected to the NAS, such as a host connected in a LAN or WAN, is alerted that the external storage device is about to be disconnected so that computer operators are aware that the external storage device is about to be disconnected. In step 806, the control program terminates data transmissions between host computer systems connected to the area network and the external storage device to be disconnected. Data can continue to be stored in other external storages devices that have not been identified for disconnection. In step 808, data stored in the temporary storage of the NAS that is directed to the external storage device to be disconnected is flushed by transmitting the data to that external storage device. In step 810, the NAS terminates any further electrical transmissions to the external storage device to be disconnected. In step 812, a display indicates that the external storage device is no longer in use and can be disconnected, as described above with reference to FIGS. 3-7B.

Although the present invention has been described in terms of particular embodiments, it is not intended that the invention be limited to these embodiments. Modifications within the spirit of the invention will be apparent to those skilled in the art. For example, in alternate embodiments of the present invention, operation of the console 210 described above with reference to FIG. 2 may include control of locks that fasten each USB plug inserted into ports 212-215 until the corresponding storage device is ready to be disconnected. In alternate embodiments of the present invention, rather than using LEDs within the console to display whether or not an external storage device is ready to be disconnected, the console may include a display, such as a monitor or liquid crystal display, that can be reconfigured according to the number of different storage devices connected to a NAS and/or provide information regarding the status of each storage device connected to the NAS. For example, the display may also include information regarding the storage capacity of each storage device, how much storage space remains on each storage device, the amount of time remaining to complete flushing the cache to the external storage device to be disconnected, and the approximate amount of time remaining before the external storage device is ready to be disconnected. In an alternate embodiment of the present invention, the buttons used to disconnect an external storage device from the NAS can be located next to each port and the console that displays information regarding whether or not the external storage device is ready to be disconnected may be located elsewhere on the NAS. In alternate embodiments of the present invention, the disconnection indicators of an NAS may also include sound generating devices that emit an auditory signal to a NAS operator indicating that an external storage device is ready to be disconnected. For example, a disconnection indicator can be a bell, a chime, or a whistle. In an alternate embodiment of the present invention, a single internal storage device can be used in place of temporary storage 204 and internal storage 206, shown in FIG. 2.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purposes of illustration and description. They are not intended to be exhaustive of or to limit the invention to the precise forms disclosed. Obviously, many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

What is claimed is:

1. A network-attached storage device comprising:
a bus that interconnects a central-processing unit and internal storage;
a port interconnected to the bus and capable of interconnecting to an external storage device;
a control program stored in the internal storage and executed by the central-processing unit that responds to an indication that the external storage device is to be disconnected; and
a disconnection indicator that indicates that the external storage device is ready to be disconnected from the network-attached storage device.

2. The device of claim 1 wherein the indication that the external storage device is to be disconnected further comprises a command that launches the computer program and is sent from a host computer in an area network that includes the network-attached storage device.

3. The device of claim 1 wherein the indication that the external storage device is to be disconnected further comprises a command that launches the computer program and is entered using a console located on the network-attached storage device.

4. The device of claim 3 wherein the console further comprise a keyboard that can be used to select the external storage device and launch the control program.

5. The device of claim 3 wherein the console further comprise one or more buttons that can be used to select the external storage device and launch the control program.

6. The device of claim 3 wherein the console further comprise one or more switches that can be used to select the external storage device and launch the control program.

7. The device of claim 1 wherein the control program responds to the indication that the external storage device is to be disconnected further comprises deactivation of the external storage device to be disconnected.

8. The device of claim 7 wherein deactivation of the external storage device further comprises terminates data transmissions between each remote computer and the external storage device and flushes data stored in temporary storage of the network-attached storage device that is directed to the external storage device.

9. The device of claim 1 wherein the disconnection indicator further comprises light electric diodes, a monitor, or a liquid crystal display that indicates whether or not the external storage device is ready to be disconnected.

10. The device of claim 1 wherein the disconnection indicator further comprises a bell, chime, or other sound generating device that indicates whether or not the external storage device is ready to be disconnected.

11. A method for disconnecting an external storage device from a network-attached storage device, the method comprising:
receiving an indication to disconnect a connected external storage device;
terminating data transmissions between each remote computer and the external storage device;
flushing data stored in temporary storage of the network-attached storage device that is directed to the external storage device; and
indicating with a disconnection indicator that the external storage device is ready to be disconnected from the network-attached storage device.

12. The device of claim 11 wherein receiving the indication to disconnect the external storage device further comprises transmitting one or more commands to the network-attached storage device from a host computer in an area network that includes the network-attached storage device.

13. The method of claim 11 wherein receiving the indication to disconnect the external storage device further comprises entering one or more commands into a console located on the network-attached storage device.

14. The method of claim 13 where in the console includes a keyboard, buttons, or switches that identify the external storage device and the external storage device is to be disconnected.

15. The method of claim 11 wherein the display further comprises light electric diodes, a monitor, or a liquid crystal display that indicates each storage device that is ready to be disconnected from the network-attached storage device.

16. The device of claim 11 wherein the disconnection indicator further comprises light electric diodes, a monitor, or a liquid crystal display that indicates whether or not the external storage device is ready to be disconnected.

17. The device of claim 11 wherein the disconnection indicator further comprises a bell, chime, or other sound generating device that indicates whether or not the external storage device is ready to be disconnected.

18. A network-attached storage device comprising:
a bus that interconnects a central-processing unit, a port, and internal storage;
a port interconnected to the bus and capable of interconnecting to an external storage device;
a lock that fastens the external storage device to the port;
a control program stored in the internal storage and executed by the central-processing unit that responds to an indication that the external storage device is to be disconnected; and
a disconnection indicator that indicates that the external storage device is ready to be disconnected from the network-attached storage device.

19. The device of claim 18 wherein the indication that the external storage device is to be disconnected further comprises a command that launches the computer program and is sent from a host computer in an area network that includes the network-attached storage device.

20. The device of claim 18 wherein the indication that the external storage device is to be disconnected further comprises a command that launches the computer program and is entered using a console located on the network-attached storage device.

21. The device of claim 20 wherein the console further comprise a keyboard that can be used to select the external storage device and launch the control program.

22. The device of claim 20 wherein the console further comprise one or more buttons that can be used to select the external storage device and launch the control program.

23. The device of claim 20 wherein the console further comprise one or more switches that can be used to select the external storage device and launch the control program.

24. The device of claim 18 wherein the control program responds to the indication that the external storage device is to be disconnected further comprises deactivation of the external storage device to be disconnected.

25. The device of claim 24 wherein deactivation of the external storage device further comprises terminates data transmissions between each remote computer and the external storage device and flushes data stored in temporary storage of the network-attached storage device that is directed to the external storage device.

26. The device of claim 18 wherein the disconnection indicator further comprises light electric diodes, a monitor, or a liquid crystal display that indicates whether or not the external storage device is ready to be disconnected.

27. The device of claim 18 wherein the disconnection indicator further comprises a bell, chime, or other sound generating device that indicates whether or not the external storage device is ready to be disconnected.

28. Computer instructions that implement a method for disconnecting an external storage device from a network-attached storage device comprising:
receiving an indication to disconnect a connected storage device;
terminating data transmissions between each remote computer and the external storage device;
flushing data stored in temporary storage of the network-attached storage device that is directed to the external storage device; and
indicating with a disconnection indicator that the external storage device is ready to be disconnected from the network-attached storage device.

29. The computer instructions of claim 28 wherein receiving the indication to disconnect the external storage device further comprises entering one or more instructions into a console located on the network-attached storage device.

30. The computer instructions of claim 29 where in the console includes a keyboard, buttons, or switches that identify the external storage device and launches a control program that deactivates the external storage device.
